(19) United States
(12) Patent Application Publication
(10) Pub. No.: US 2026/0322959 A1
(43) Pub. Date: Oct. 15, 2026

(54) CORRECTION METHOD AND PROJECTION APPARATUS

(71) Applicant: SEIKO EPSON CORPORATION, Tokyo (JP)

(72) Inventor: Yutaro IIJIMA, MATSUMOTO-SHI, NAGANO-KEN (JP)

(21) Appl. No.: 19/644,440

(22) Filed: Apr. 10, 2026

(30) Foreign Application Priority Data
Apr. 11, 2025 (JP) 2025-065478

(51) Int. Cl. H04N 9/31; G01B 11/22; G01S 7/497; G01S 17/08

(52) U.S. Cl. CPC H04N 9/3185; G01B 11/22; G01S 7/497; G01S 17/08

(57) ABSTRACT

A processor of a projection apparatus acquires multiple pieces of depth information indicating distances to multiple positions and multiple pieces of intensity information indicating intensities of reflected light at the multiple positions based on an output from a distance sensor, calculates, for each of the multiple positions, an evaluation value used to evaluate accuracy of measurement of the distance indicated by the corresponding depth information based on the intensity indicated by the corresponding intensity information, determines whether the evaluation value satisfies a first condition under which the measurement accuracy is evaluated, determines whether the evaluation value determined not to satisfy the first condition satisfies a second condition in which the measurement accuracy is more relaxed than in the first condition, and generates a parameter that specifies a projection receiving surface based on at least one of the depth information derived from the reflected light providing the evaluation value satisfying the first condition and the depth information derived from the reflected light providing the evaluation value satisfying the second condition.

The present application is based on, and claims priority from JP Application Serial Number 2025-065478, filed Apr. 11, 2025, the disclosure of which is hereby incorporated by reference herein in its entirety.

### BACKGROUND

### 1. Technical Field

The present disclosure relates to a correction method and a projection apparatus.

### 2. Related Art

In related art, there is a known technology for determining a normal vector with respect to a projection receiving surface based on the distance to the projection receiving surface measured with a distance sensor and correcting a projection image by using the determined normal vector.

For example, WO 2022/193560 discloses a projector that acquires information on the depths of multiple light points on a projection receiving surface by using a time-of-flight (ToF) sensor and determines a normal vector with respect to the projection receiving surface based on multiple pieces of the acquired depth information. The projector disclosed in WO 2022/193560 acquires information on the amount of offset of the projector based on the determined normal vector with respect to the projection receiving surface, and corrects a projection image based on the acquired offset information.

WO 2022/193560 is an example of the related art.

In the technology disclosed in WO 2022/193560, however, when the projection receiving surface inclines with respect to the ToF sensor by a large angle or when the ToF sensor is separate from the projection receiving surface by a long distance, the accuracy of the measurement of the information on the depths of the multiple light points may decrease. When the shape of an image to be projected onto the projection receiving surface is corrected based on the depth information measured at reduced accuracy, the result of the correction also deteriorates. However, when the shape of the image is corrected using only highly accurate depth information provided from the ToF sensor, the distance and the angle between the projection receiving surface and the projection apparatus at which correction is possible may be limited in some cases.

### SUMMARY

A correction method according to an aspect of the present disclosure is a method for correcting a projection image to be projected by a projection apparatus onto a projection receiving surface, the method including: acquiring multiple pieces of depth information indicating multiple distances from a distance sensor to multiple positions on the projection receiving surface based on an output from the distance sensor, the distance sensor configured to irradiate the projection receiving surface with radiation light and receive reflected light that is the radiation light reflected off the projection receiving surface; acquiring multiple pieces of intensity information indicating intensities of the reflected light at the multiple positions; calculating, for each of the multiple positions, an evaluation value used to evaluate accuracy of measurement of the distance indicated by the corresponding depth information based on the intensity indicated by the corresponding intensity information; determining whether the evaluation value satisfies a first condition under which the measurement accuracy is evaluated; determining whether the evaluation value determined not to satisfy the first condition satisfies a second condition in which the measurement accuracy is more relaxed than in the first condition; generating a parameter that specifies the projection receiving surface based on at least one of the depth information derived from the reflected light providing the evaluation value satisfying the first condition and the depth information derived from the reflected light providing the evaluation value satisfying the second condition; and correcting the projection image based on the parameter.

A projection apparatus according to another aspect of the present disclosure is a projection apparatus including a projector configured to project a projection image onto a projection receiving surface; and one or more processors, the one or more processors configured to acquire multiple pieces of depth information indicating multiple distances from a distance sensor to multiple positions on the projection receiving surface based on an output from the distance sensor, the distance sensor configured to irradiate the projection receiving surface with radiation light and receive reflected light that is the radiation light reflected off the projection receiving surface, acquire multiple pieces of intensity information indicating intensities of the reflected light at the multiple positions, calculate, for each of the multiple positions, an evaluation value used to evaluate accuracy of measurement of the distance indicated by the corresponding depth information based on the intensity indicated by the corresponding intensity information, determine whether the evaluation value satisfies a first condition under which the measurement accuracy is evaluated, determine whether the evaluation value determined not to satisfy the first condition satisfies a second condition in which the measurement accuracy is more relaxed than in the first condition, generate a parameter that specifies the projection receiving surface based on at least one of the depth information derived from the reflected light providing the evaluation value satisfying the first condition and the depth information derived from the reflected light providing the evaluation value satisfying the second condition, and correct the projection image based on the parameter.

### BRIEF DESCRIPTION OF THE DRAWINGS

FIG. 1 is a block diagram showing the configuration of a projection apparatus.

FIG. 2 shows the configuration of a projector.

FIG. 3 shows multiple measurement positions on a projection receiving surface.

FIG. 4 shows the configuration of a light receiving sensor provided in a distance sensor.

FIG. 5 shows an example of a depth information map and an intensity information map.

FIG. 6 an example of a classification table.

FIG. 7 shows the depth information at a pixel in multiple frames.

FIG. 8 shows depth information at adjacent pixels.

FIG. 9 is a flowchart showing the operation of the projection apparatus.

### DESCRIPTION OF EMBODIMENTS

### 1. Configuration of Projection Apparatus

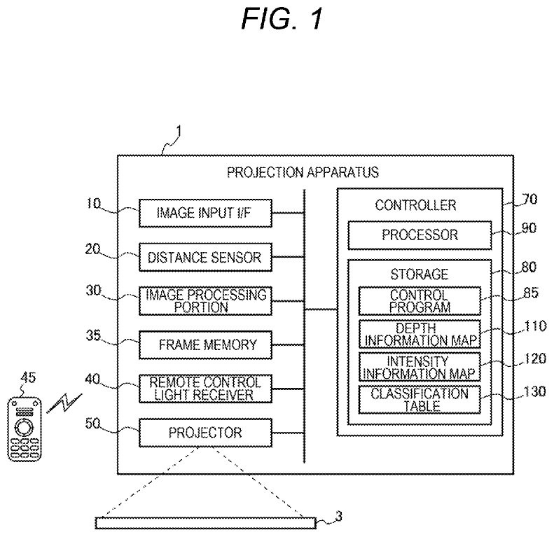

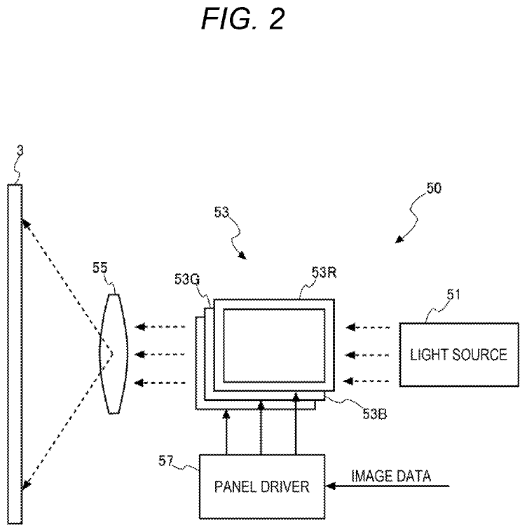

FIG. 1 is a block diagram showing the configuration of a projection apparatus 1, and FIG. 2 shows the configuration of a projector 50 provided in the projection apparatus 1. The configuration of the projection apparatus 1 will be described with reference to FIGS. 1 and 2.

The projection apparatus 1 includes an image input interface 10, a distance sensor 20, an image processing portion 30, a frame memory 35, a remote control light receiver 40, the projector 50, and a controller 70. An interface is hereinafter abbreviated to I/F.

The image input I/F 10 is an interface to which an image signal transmission cable can be coupled, such as an high-definition multimedia interface (HDMI) or a display port, and includes an interface circuit that conforms to a predetermined communication standard. HDMI is a registered trademark. An image signal supplied from an external apparatus such as a personal computer is input to the image input I/F 10. The image input I/F 10 outputs image data contained in the input image signal to the image processing portion 30.

The distance sensor 20 measures the distance to a measured object located around the projection apparatus 1. In the present embodiment, a projection receiving surface 3 is a measurement target, and the distance sensor 20 irradiates the projection receiving surface 3 with radiation light from a light emitting element provided in the distance sensor 20, and receives the radiated radiation light reflected off the projection receiving surface 3. The distance sensor 20 measures the distances between the distance sensor 20 and multiple measurement positions on the projection receiving surface 3 based on the result of the detection of the reflected light, and outputs sensor data indicating the result of the measurement to the controller 70. The controller 70 causes a storage 80, which will be described later, to store the sensor data input from the distance sensor 20. The present embodiment will be described with reference to a case where a ToF sensor is used as the distance sensor 20, but the distance sensor 20 may be another sensor such as a light-detection-and-ranging (LiDAR) sensor.

A light receiving sensor provided in the distance sensor 20 has a configuration in which multiple light receiving elements are regularly arranged at a light receiving surface of the light receiving sensor. The lateral direction of the light receiving surface is defined as an x-axis, and the longitudinal direction of the light receiving surface is defined as a y-axis. The light receiving sensor has six pixels in each of the x-axis direction and the y-axis direction. The number of pixels, that is, the resolution of the light receiving sensor is therefore 6 pixels×6 pixels.

The frame memory 35 is coupled to the image processing portion 30. The frame memory 35 has multiple banks. The banks each have a storage capacity that allows image data corresponding to one frame to be written into the bank. The frame memory 35 is configured, for example, with a synchronous dynamic random access memory (SDRAM). The image processing portion 30 loads the image data input from the image input I/F 10 into the frame memory 35.

The image processing portion 30 performs image processing on the image data loaded into the frame memory 35. Examples of the image processing performed by the image processing portion 30 may include resolution conversion or resizing, distortion correction, shape correction, digital zooming, and adjustment of the tint and luminance of an image. The image processing portion 30 performs processing specified by the controller 70, and performs the processing by using a parameter input from the controller 70 as necessary. The image processing portion 30 can, of course, perform some of the multiple types of image processing described above in combination. The image processing portion 30 reads, from the frame memory 35, the image data loaded into a bank selected by the controller 70 and outputs the read image data to the projector 50.

The image processing portion 30 and the frame memory 35 are each configured, for example, with an integrated circuit. Examples of the integrated circuit may include a large scale integration (LSI) circuit, an application specific integrated circuit (ASIC), a programmable logic device (PLD), a field-programmable gate array (FPGA), a system-on-a-chip (SoC), and the like. The integrated circuit may include an analog circuit as a portion of the configuration thereof, or the controller 70 and the integrated circuit may be combined with each other.

The remote control light receiver 40 receives an infrared signal transmitted from a remote control 45. The remote control 45 includes multiple buttons such as a power button, a source switching button, a volume button, a projection start button, and a projection end button. The remote control 45 transmits an infrared signal corresponding to a button operated by a user to the projection apparatus 1. The remote control light receiver 40 outputs an operation signal corresponding to the received infrared signal to the controller 70. The operation signal is a signal corresponding to a button of the remote control 45 operated by the user.

FIG. 2 shows the configuration of the projector 50.

The configuration of the projector 50 will now be described with reference to FIG. 2.

The projector 50 modulates light output from a light source 51 to generate image light, enlarges and projects the generated image light via an optical unit 55. The projector 50 includes the light source 51, three liquid crystal panels 53R, 53G, and 53B serving as light modulators, the optical unit 55, and a panel driver 57. The liquid crystal panels 53R, 53G, and 53B provided in the projector 50 may be hereinafter collectively referred to as liquid crystal panels 53.

The light source 51 includes a discharge-type light source lamp such as an ultrahigh-pressure mercury lamp or a metal halide lamp, or a solid-state light source such as a light emitting diode or a semiconductor laser. The light output from the light source 51 is incident on the liquid crystal panels 53. The liquid crystal panels 53R, 53G, and 53B are each configured, for example, with a transmissive liquid crystal panel in which a liquid crystal material is encapsulated between a pair of transparent substrates. The liquid crystal panel 53R modulates red light, the liquid crystal panel 53G modulates green light, and the liquid crystal panel 53B modulates blue light. Each of the liquid crystal panels has a pixel region including multiple pixels arranged in a matrix, and is configured to apply a drive voltage to the liquid crystal material on a pixel basis.

The image data output by the image processing portion 30 is input to the panel driver 57. The panel driver 57 applies a drive voltage according to the input image data to each of the pixels in the pixel region to set the pixel to have light transmittance according to the image data. The light output from the light source 51 is modulated on a pixel basis when passing through the pixel regions of the liquid crystal panels 53R, 53G, and 53B, so that image light corresponding to the image data is formed on a color light basis. The multiple types of thus formed color image light are combined with one another on a pixel basis by a light combining system that is not shown into image light representing a color image. The optical unit 55 includes a projection lens, enlarges the image light modulated by the liquid crystal panels 53R, 53G, and 53B, and projects the enlarged image light onto the projection receiving surface 3.

Returning to FIG. 1, the description of the configuration of the projection apparatus 1 will be resumed.

The controller 70 is a computer apparatus including the storage 80 and a processor 90.

The storage 80 includes at least a nonvolatile semiconductor memory. The storage 80 may include a volatile semiconductor memory or an auxiliary storage device in addition to the nonvolatile semiconductor memory. The storage 80 stores a control program 85, the sensor data indicating a result of the measurement performed by the distance sensor 20, a depth information map 110, an intensity information map 120, a classification table 130, and various setting data. The depth information map 110, the intensity information map 120, and the classification table 130 will be described later.

The processor 90 is an arithmetic processing device including a central processing unit (CPU) or a micro-processing unit (MPU). The processor 90 may be configured with a single processor or multiple processors. The processor 90 may instead be configured with an SoC (system-on-a-chip) integrated with a portion or the entirety of the storage 80 or any other circuit. The processor 90 may be a combination of a CPU that executes a program and a digital signal processor (DSP) that performs predetermined arithmetic processing. Furthermore, all functions of the processor 90 may be implemented in hardware, or a programmable device may be used to realize the functions.

### 2. Operation of Projection Apparatus

The sensor data indicating a result of the measurement performed by the distance sensor 20 will first be described.

The sensor data output by the distance sensor 20 contains depth information DI and intensity information SI. The depth information DI is information indicating the distances from the distance sensor 20 to the multiple measurement positions on the projection receiving surface 3. The intensity information SI is information indicating the received light intensity of the reflected light received by the distance sensor 20. The reflected light is the radiation light radiated by the distance sensor 20 and reflected off the projection receiving surface 3.

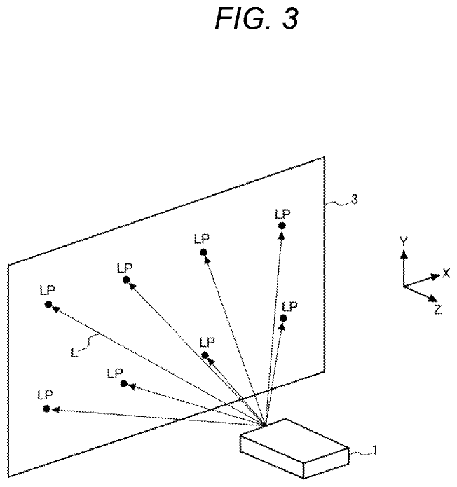

FIG. 3 shows the multiple measurement positions on the projection receiving surface 3.

FIG. 3 shows a state in which the projection apparatus 1 and the projection receiving surface 3 are installed in an XYZ coordinate system, which is a world coordinate system. The Y-axis of the XYZ coordinate system corresponds to the vertical direction, and the X-axis and the Z-axis correspond to the horizontal direction. The optical axis of the projection apparatus 1 is substantially parallel to the Z-axis. The optical axis of the projection apparatus 1 is, for example, the optical axis of the projection lens provided in the optical unit 55. Note that the term “being substantially parallel” means being parallel with an error that falls within an allowable range. When the distance sensor 20 is a ToF sensor, the distance sensor 20 irradiates the multiple measurement positions on the projection receiving surface 3 with multiple line laser beams L. The multiple line laser beams L with which the projection receiving surface 3 is irradiated form multiple light points LP on the projection receiving surface 3. The distance sensor 20 outputs the depth information DI indicating the multiple distances from the distance sensor 20 to the multiple light points LP formed on the projection receiving surface 3 based on a period from the time at which the distance sensor 20 radiates the line laser beams L to the time at which the light receiving sensor provided in the distance sensor 20 detects reflected light from the multiple light points LP. The controller 70 acquires the depth information DI output from the distance sensor 20. FIG. 3 shows a case where the light points LP are formed at 8 positions out of 36 positions on the projection receiving surface 3, which is the largest number of positions at which the distance sensor 20 can perform the detection. The distance sensor 20 may irradiate the projection receiving surface 3 with planar laser light from a surface emitting laser instead of irradiating the projection receiving surface 3 with the multiple line laser beams L as described above. In this case, the multiple light receiving elements discretely disposed in the distance sensor 20 sense the reflected light from the projection receiving surface 3.

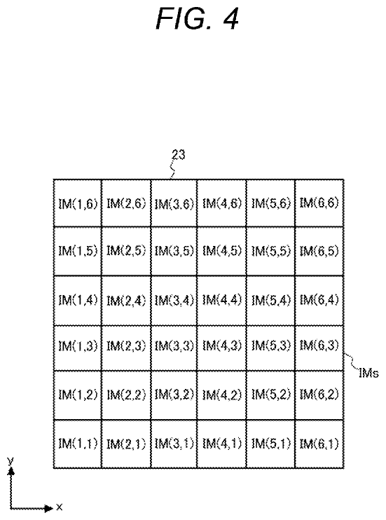

FIG. 4 shows the configuration of the light receiving sensor provided in the distance sensor 20. The distance sensor 20 has the configuration in which six pixels are regularly arranged in each of the x-axis direction and the y-axis direction, as shown in FIG. 4. The multiple pixels provided in the light receiving sensor are collectively referred to as a pixel group IMs. The pixel IMs is configured with 36 pixels including a pixel IM(1,1) to a pixel IM(6,6), as shown in FIG. 4. Note that the numbers in the parentheses are identification numbers used to identify the pixels arranged in the x-axis direction and the y-axis direction. In FIG. 4, the lower left pixel is referred to as IM(1,1), and the upper right pixel is referred to as IM(6,6). The pixels arranged in the same row as the IM(1,1) are assigned the same identification number indicating the position in the y-axis direction, such as IM(2,1), IM(3,1), IM(4,1), IM(5,1), and IM(6,1). The pixels arranged in the same column as the IM(1,1) are assigned the same identification number indicating the position in the x-axis direction, such as IM(1,2), IM(1,3), IM(1,4), IM(1,5), and IM(1,6). The same applies to the other pixels disposed at the light receiving surface.

Let n be a variable indicating the number of times the distance sensor 20 performs the measurement. Note that n is any natural number. The controller 70 acquires the sensor data from the distance sensor 20 n times, which are multiple times. That is, the sensor data measured at multiple different points in time are acquired. The sensor data from the 36 pixels produced in the first measurement is referred to as a first frame, and the sensor data produced in the n-th measurement is referred to as an n-th frame.

The depth information from the pixel IM(1,1) in the first frame is referred to as DI(1,1,1), and the depth information from the pixel IM(1,1) in the n-th frame is referred to as DI(1,1,n). The first and second numerals out of the numerals shown in the parentheses are identification numbers used to identify the pixel disposed at a corresponding position in the x-axis direction and the y-axis direction, and the third numeral is an identification number used to identify the frame. Similarly, the intensity information from the pixel IM(1,1) in the first frame is referred to as SI(1,1,1), and the intensity information from the pixel IM(1,1) in the n-th frame is referred to as SI(1,1,n).

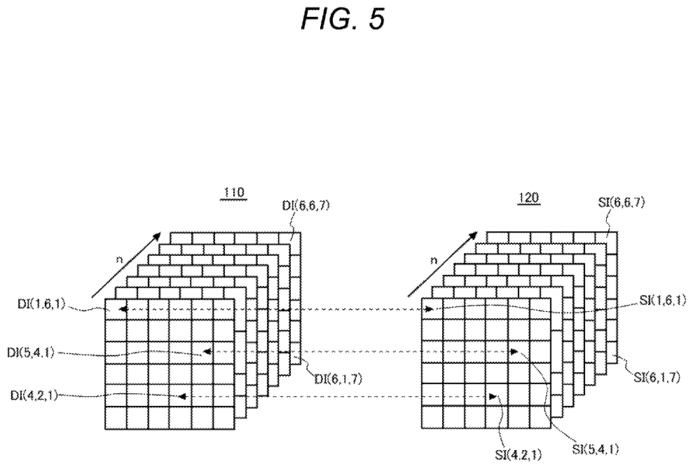

FIG. 5 shows a depth information map 110 and an intensity information map 120 generated by the controller 70. The controller 70 generates the depth information map 110 and the intensity information map 120 based on the sensor data input from the distance sensor 20.

The depth information map 110 is configured with n frames from the first frame to the n-th frame. The depth information map 110 of the first frame contains the depth information DI(1,1,1) to DI(6,6,1) at the pixels IM(1,1) to IM(6,6) in the first frame. The depth information map 110 of the second frame contains the depth information DI(1,1,2) to DI(6,6,2) at the pixels IM(1,1) to IM(6,6) in the second frame. The same applies to the depth information maps 110 of the third frame to the n-th frame.

The intensity information map 120 is configured with n frames from the first frame to the n-th frame. The intensity information map 120 of the first frame contains the intensity information SI(1,1,1) to SI(6,6,1) at the pixels IM(1,1) to IM(6,6) in the first frame. The intensity information map 120 of the second frame contains the intensity information SI(1,1,2) to SI(6,6,2) at the pixels IM(1,1) to IM(6,6) in the second frame. The same applies to the third to n-th frames.

Having generated the depth information map 110 and the intensity information map 120, the controller 70 next generates an evaluation value used to evaluate the accuracy of the measurement of the distance indicated by the depth information. The evaluation value generated by the controller 70 includes a first evaluation value indicating reliability and a second evaluation value indicating pseudo reflectance.

The first evaluation value indicating the reliability is calculated by Expression (1) below based on the average of the reflected light intensities and the standard deviation of the reflected light intensities. Hereinafter, the average of the reflected light intensities is referred to as an “intensity average”, and the standard deviation of the reflected light intensities is referred to as an “intensity standard deviation”.

First evaluation value={(intensity average−intensity standard deviation)}/{(intensity average)−0.8}/0.1 (1)

In Expression (1) described above, the first evaluation value is calculated as “0” when the ratio of the intensity standard deviation to the intensity average is 80%, and as “1” when the ratio is 90%.

The second evaluation value is calculated by Expression (2) below.

Second evaluation value=reflected light intensity I1/radiation light intensity I0 (2)

The reflected light intensity I1 is the intensity of the light received with the light receiving elements provided in the ToF sensor, which is the distance sensor 20.

The radiation light intensity I0 is the intensity of the light radiated by the light emitting element provided in the ToF sensor, which is the distance sensor 20.

The radiation light intensity I0 may be a measured value of the radiation light intensity of the light output from the light source of the ToF sensor and stored in advance in the storage 80, or a specification value of the radiation light intensity of the light from the light source of the ToF sensor. The radiation light intensity 10 may instead be a value calculated from the voltage supplied to the light source of the ToF sensor with the aid of a table.

The term “pseudo” is used because there is reflected light that cannot be received with the light receiving elements provided in the ToF sensor.

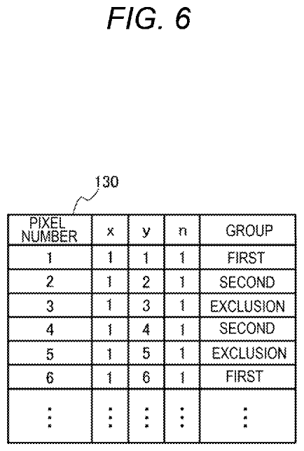

FIG. 6 shows a classification table 130 in which results of the evaluation of the pixels in n depth information maps 110 are registered.

The controller 70 then determines whether the first evaluation value, the second evaluation value, and the distance indicated by the depth information satisfy a first condition or a second condition, and classifies the depth information at each of the pixels in the depth information maps 110 into any of a first group, a second group, and an exclusion group. The controller 70 registers the coordinate value of each of the classified pixels and the result of the classification in the classification table 130.

The first group is a group containing pixels so determined that the distance indicated by the depth information has been measured with high accuracy.

The second group is a group containing pixels so determined that the distance indicated by the depth information has been measured with accuracy lower than that in the first group.

The exclusion group is a group containing pixels providing depth information excluded from those used to generate three-dimensional parameters that define the projection receiving surface 3.

The controller 70 classifies the depth information at a pixel where the first evaluation value, the second evaluation value, and the depth information satisfy the first condition, which will be shown below, into the first group.

The first condition is, for example, that the value of the distance indicated by the depth information is greater than 0 [mm], the first evaluation value is “1”, and the second evaluation value is greater than “30”.

The controller 70 classifies a pixel where the first evaluation value, the second evaluation value, and the depth information satisfy the first condition described above into the first group.

The controller 70 classifies the depth information at a pixel where the first evaluation value, the second evaluation value, and the depth information satisfy the second condition, which will be shown below, into the second group.

The second condition is, for example, that the value of the distance indicated by the depth information is greater than 2500 [mm], the first evaluation value is “0”, and the second evaluation value is greater than “0”.

The controller 70 classifies a pixel where the first evaluation value, the second evaluation value, and the depth information satisfy the second condition described above into the second group.

The controller 70 classifies a pixel where the first evaluation value, the second evaluation value, and the depth information do not satisfy either the first condition or the second condition into the exclusion group.

The classification table 130 contains pixel numbers, corresponding values of x, y, and n, and groups indicating results of the classification.

The pixel numbers are identification numbers assigned to the pixels IM(1,1,1) to IM(6,6,n) in ascending order of the numerals in the parenthesis.

The variable x is an identification number used to identify a pixel at a position in the x-axis direction.

The variable y is an identification number used to identify a pixel at a position in the y-axis direction.

The variable n is an identification number used to identify the frame.

Having classified the pixels in the depth information map 110 of n frames into the first group, the second group, or the exclusion group, the controller 70 selects, based on the results of the classification, pixel numbers to be used to generate the parameters that specify the projection receiving surface 3. The controller 70 generates the parameters that specify the three-dimensional shape of the projection receiving surface 3 based on the depth information at the selected pixels.

The controller 70 first determines whether the number of the pixel numbers classified into the first group is greater than or equal to a first set value set in advance. When the number of the pixel numbers classified into the first group is greater than or equal to the first set value set in advance, the controller 70 generates the parameters that specify the projection receiving surface 3 based on the depth information at the pixels having the pixel numbers classified into the first group.

When the number of the pixel numbers classified into the first group is smaller than the first set value, the controller 70 determines whether the number of the pixel numbers classified into the second group is greater than or equal to a second set value set in advance. The second set value to be used may be equal to the first set value, or may differ from the first set value. When the number of the pixel numbers classified into the second group is greater than or equal to the second set value, the controller 70 generates the parameters that specify the projection receiving surface 3 based on the depth information at the pixels having the pixel numbers classified into the second group. In this process, the controller 70 may also use the depth information at the pixels having the pixel numbers classified into the first group to generate the parameters that specify the projection receiving surface 3.

When the number of the pixel numbers classified into the first group is smaller than the first set value, and the number of the pixel numbers classified into the second group is smaller than the second set value, the controller 70 does not generate the parameters that specify the projection receiving surface 3. That is, the parameters that specify the projection receiving surface 3 are not generated by using the depth information at the pixels having the pixel numbers classified into the exclusion group.

The controller 70 then generates the parameters that specify the projection receiving surface 3 based on the acquired depth information DI and intensity information SI.

Specifically, the controller 70 may generate the parameters described above by using the intensities indicated by the intensity information SI as a weight to calculate a weighted average of the distances indicated by the depth information DI.

Instead, to generate the parameters that specify the projection receiving surface 3 by using the pixels classified into the second group, the controller 70 may remove outliers from the distances indicated by the depth information DI by using random sample consensus (RANSAC). In this case, the controller 70 may instead remove outliers from the distances indicated by the depth information DI based on the result of comparison between the intensities indicated by the intensity information SI and a threshold, and generate the parameters described above based on the distances indicated by the depth information DI from which the outliers have been removed.

The controller 70 may still instead generate the parameters described above by using a weighted least squares method that uses coordinates calculated by using the intensities indicated by the intensity information SI as the weights, and also using the distances indicated by the depth information DI.

Note that the “parameters that specify the projection receiving surface 3” may, for example, be a normal vector with respect to the projection receiving surface 3, or the coefficients of the equation of a plane that specifies the position of the projection receiving surface 3 in the XYZ coordinates.

2A. Case where Weighted Average is Calculated

The controller 70 may generate the parameters that specify the projection receiving surface 3 based, for example, on a weighted average that is the average of the distances indicated by the depth information DI of seven frames, the first frame to the seventh frame, weighted by the intensities indicated by the multiple pieces of intensity information SI corresponding to the multiple pieces of depth information DI.

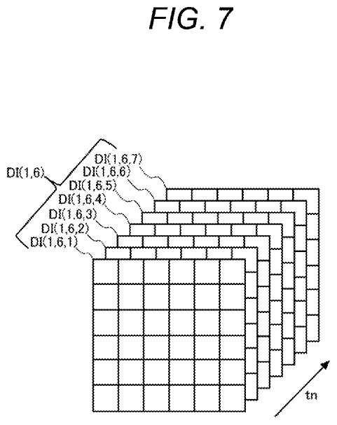

FIG. 7 shows the depth information DI at the pixel IM(1,6) in multiple frames. As an example, let a distance di be the distance indicated by the depth information DI(1,6,i) at the pixel IM(1,6), and a weight wi be the intensity indicated by the intensity information SI(1,6,i) corresponding to the depth information DI(1,6,i), and the controller 70 uses Expression (3) below to calculate a distance dff, which is a weighted average of the distances from the distance sensor 20 to the pixel IM(1,6) across the frames. Note that i is an integer greater than or equal to one but smaller than or equal to seven.

$$dff = \frac{{\sum }_{i = 1}^{7} widi}{{\sum }_{i = 1}^{7} wi} \qquad ( 3 )$$

In FIG. 7, the same applies to the pixels IM(1,1) to IM(6,6) excluding the pixel IM(1,6). In the example shown in FIG. 7, seven frames from the first frame to the seventh frame are shown. Note, however, that even when the number of the frames differs from that in FIG. 7, the same applies except that the number corresponding to the number of the frames in Expression (3) is a different number.

The controller 70 may generate the parameters that specify the projection receiving surface 3 based on a weighted average of the distances indicated by multiple pieces of depth information DI at at least some of the multiple measurement positions adjacent to each other out of the multiple measurement positions on the projection receiving surface 3. Note that the weights in this case are the intensities indicated by the multiple pieces of intensity information SI corresponding to the multiple pieces of the depth information DI.

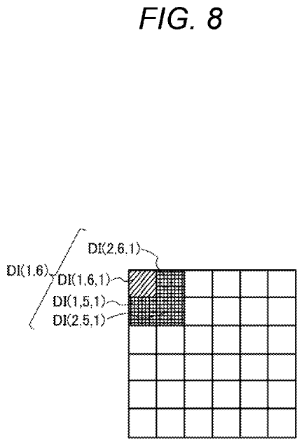

FIG. 8 shows the depth information DI at the pixel IM(1,6) and the pixels IM(1,5), IM(2,5), and IM(2,6) adjacent to the pixel IM(1,6) in the first frame. Let a distance d1 be the distance indicated by the depth information DI(1,6,1) at the pixel IM(1,6), and a weight w1 be the intensity indicated by the intensity information SI(1,6,1) corresponding to the depth information DI(1,6,1). Let a distance d2 be the distance indicated by the depth information DI(1,5,1) at the pixel IM(1,5), and a weight w2 be the intensity indicated by the intensity information SI(1,5,1) corresponding to the depth information DI(1,5,1). Let a distance d3 be the distance indicated by the depth information DI(2,5,1) at the pixel IM(2,5), and a weight w3 be the intensity indicated by the intensity information SI(2,5,1) corresponding to the depth information DI(2,5,1). Let a distance d4 be the distance indicated by the depth information DI(2,6,1) at the pixel IM(2,6), and a weight w4 be the intensity indicated by the intensity information SI(2,6,1) corresponding to the depth information DI(2,6,1). In this case, the controller 70 may use Expression (4) below to calculate a distance dmf, which is a weighted average of the distances at the pixel IM(1,6) averaged across the pixels adjacent thereto. Note that i is an integer greater than or equal to one but smaller than or equal to four.

$$dmf = \frac{{\sum }_{i = 1}^{4} widi}{{\sum }_{i = 1}^{4} wi} \qquad ( 4 )$$

In FIG. 8, the same applies to the pixels IM(1,1) to IM(6,6) excluding the pixel IM(1,6).

The controller 70 may combine the method described with reference to FIG. 7 for calculating the distance dff, which is the weighted average across the frames, with the method described with reference to FIG. 8 for calculating the distance dmf, which is the weighted average across the adjacent pixels IM.

Specifically, the controller 70 may calculate the distance dff, which is the weighted average across the frames and corresponding to the pixels IM(1,1) to IM(6,6), and then use the distance dff to calculate the distance dmf, which is the weighted average across the adjacent pixels IM.

Instead, the controller 70 may calculate the distance dmf, which is the weighted average across the adjacent pixels IM at the pixels IM(1,1) to IM(6,6), and then use the distance dmf to calculate the distance dff, which is the weighted average across the frames and corresponding to the pixels IM(1,1) to IM(6,6).

2B. Case where Outliers are Removed

The controller 70 may compare the intensities indicated by multiple pieces of intensity information SI with a threshold, extract intensity information SI indicating intensities exceeding the threshold, and generate the parameters that specify the projection receiving surface 3 based on the average of the distances indicated by multiple pieces of depth information DI corresponding to the multiple pieces of intensity information SI.

For example, when the intensities indicated by the intensity information SI(1,6,2), the intensity information SI(1,6,3), and the intensity information SI(1,6,5) out of the intensities indicated by the multiple pieces of intensity information SI(1,6,i) (i is integer greater than or equal to one but smaller than or equal to seven) at the pixel IM(1,6) in multiple frames exceed the threshold, the controller 70 sets the average of a distance d2 indicated by the depth information DI(1,6,2), a distance d3 indicated by the depth information DI(1,6,3), and a distance d5 indicated by the depth information DI(1,6,5) in FIG. 7 as a distance dfs from the projection apparatus 1 to the pixel IM(1,6).

In FIG. 7, the same applies to the pixels IM(1,1) to IM(6,6) excluding the pixel IM(1,6). In the example shown in FIG. 7, seven frames from the first frame to the seventh frame are shown. Note, however, that the same applies to a case where the number of the frames differs from that in FIG. 7.

Instead, when the intensities indicated by the intensity information SI(1,6,1), the intensity information SI(1,5,1), and the intensity information SI(2,6,1) out of the multiple pieces of intensity information SI at the pixel IM(1,6) and the pixel IM(1,5), the pixel IM(2,5), and the pixel IM(2,6) adjacent to the pixel IM(1,6) in the first frame exceed the threshold, the controller 70 sets the average of the distance d1 indicated by the depth information DI(1,6,1), the distance d2 indicated by the depth information DI(1,5,1), and the distance d4 indicated by the depth information DI(2,6,1) in FIG. 8 as a distance dms from the projection apparatus 1 to the pixel IM(1,6).

The controller 70 may combine the method described with reference to FIG. 7 for calculating the distance dfs, which is the average across the frames, with the method described with reference to FIG. 8 for calculating the distance dms, which is the average across the adjacent pixels IM.

Specifically, the controller 70 may calculate the distance dfs, which is the average across the frames and corresponding to the pixels IM(1,1) to IM(6,6), and then use the distance dfs to calculate the distance dms, which is the average across the adjacent pixels IM.

Instead, the controller 70 may calculate the distance dms, which is the average across the adjacent pixels IM at the pixels IM(1,1) to IM(6,6), and then use the distance dms to calculate the distance dfs, which is the average across the frames and corresponding to the pixels IM(1,1) to IM(6,6).

2C. Case where Weighted Least Squares Method is Used

The controller 70 calculates the coordinates of the center point of each of the pixel IM(1,1) to the pixel IM(6,6) in the XYZ coordinate system based on the distances from the projection apparatus 1 to the center point that are indicated by multiple pieces of depth information DI at multiple points in time. Since the coordinates of the center point of each of the pixels IM(1,1) to IM(6,6) are calculated based on the multiple pieces of depth information DI at the multiple points in time, there are as many coordinates as the number of the frames. The controller 70 may fit a plane to the point group of the center points of the pixels IM(1,1) to IM(6,6), the number of the center points being equal to the number of the frames. The controller 70 fits the plane by using the weighted least squares method using as the weights the multiple pieces of intensity information SI at the multiple points in time.

For example, when the equation of the projection receiving surface 3 is expressed by pX+qY+rZ=1 as shown in FIG. 3, and the coordinates of the point group of the center points are expressed by (X, Y, Z)=(Xk, Yk, Zk), where k is an integer from 1 to u, the controller 70 generates p, q, and r that minimize mn expressed by Expression (5) below.

$${m}_{n} = min {\sum }_{k = 1}^{u} \frac{{( 1 - {pX}_{k} - {qY}_{k} - {rZ}_{k} )}^{2}}{{σ}_{k}^{2}} \qquad ( 5 )$$

The controller 70 uses each of the multiple pieces of intensity information SI corresponding to the multiple pieces of depth information DI at the multiple points in time as ok in Expression (5) described above. The multiple pieces of intensity information SI each correspond to each of the coordinates (X, Y, Z)=(Xk, Yk, Zk) of the point group of the center points.

The controller 70 outputs the generated correction parameters p, q, and r to the image processing portion 30. The image processing portion 30 corrects the shape of a projection image by using the correction parameters input from the controller 70.

The image processing portion 30 outputs image data on the corrected projection image to the panel driver 57 of the projector 50. The projection image having a shape corrected by the correction parameters is thus projected onto the projection receiving surface 3 by the projector 50.

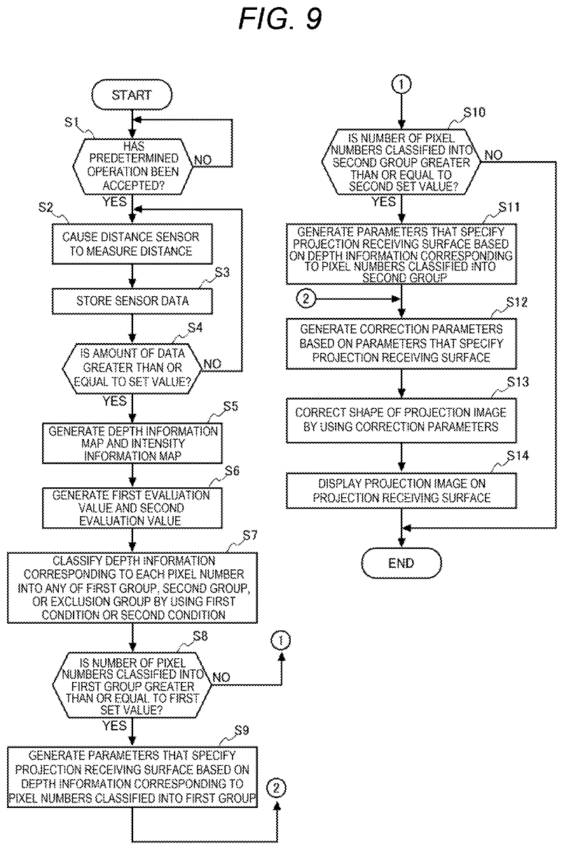

FIG. 9 is a flowchart showing the operation of the projection apparatus 1.

The operation of the projection apparatus 1 will be described with reference to the flowchart shown in FIG. 9.

The controller 70 first determines whether it has accepted a predetermined operation. For example, the user presses a predetermined button with which the remote control 45 is provided to cause the projection apparatus 1 to perform shape correction. When the predetermined button of the remote control 45 is pressed and an operation signal corresponding to the operation of the predetermined button is input via the remote control light receiver 40, the controller 70 determines that it has accepted the predetermined operation. When the controller 70 has not accepted the predetermined operation (NO in step S1), the controller 70 waits until it accepts the predetermined operation.

Having accepted the predetermined operation (step YES in S1), the controller 70 causes the distance sensor 20 to measure the distance to the projection receiving surface 3 (step S2), and causes the storage 80 to store the sensor data input from the distance sensor 20 (step S3).

The controller 70 then determines whether the amount of the sensor data stored in the storage 80 is greater than or equal to a set value set in advance (step S4). When the amount of the sensor data stored in the storage 80 is greater than or equal to the set value, the controller 70 determines that the amount of the sensor data stored in the storage 80 is greater than or equal to n frames.

When it is determined that the amount of the sensor data is not greater than or equal to the set value (NO in step S4), the controller 70 returns to step S2 and causes the distance sensor 20 to continue the distance measurement.

When the amount of the sensor data is greater than or equal to the set value (YES in step S4), the controller 70 generates the depth information map 110 and the intensity information map 120 shown in FIG. 5 based on the sensor data stored in the storage 80 (step S5). The controller 70 associates the depth information DI(1,1,n) and the intensity information SI(1,1,n) with each other for each of the pixels in the pixel group IMs to generate the depth information map 110 and the intensity information map 120.

The controller 70 then generates the evaluation value used to evaluate the accuracy of the measurement of the distance indicated by the depth information (step S6). The controller 70 refers to the intensity information map 120, generates the first evaluation value in accordance with Expression (1) described above, and generates the second evaluation value in accordance with Expression (2) described above.

The controller 70 then classifies the depth information at each of the pixels in the depth information maps 110 into any of the first group, the second group, and the exclusion group based on the first evaluation value, the second evaluation value, and the distance indicated by the depth information by using the first condition or the second condition (step S7). The controller 70 registers the coordinate value of each of the classified pixels and the result of the classification in the classification table 130 shown in FIG. 6.

The controller 70 then determines whether the number of the pixel numbers classified into the first group is greater than or equal to the first set value set in advance (step S8). When the number of the pixel numbers classified into the first group is greater than or equal to the first set value set in advance (YES in step S8), the controller 70 generates the parameters that specify the projection receiving surface 3 based on the depth information at the pixels having the pixel numbers classified into the first group (step S9).

When the number of the pixel numbers classified into the first group is smaller than the first set value set in advance (NO in step S8), the controller 70 determines whether the number of the pixel numbers classified into the second group is greater than or equal to the second set value set in advance (step S10).

When the number of the pixel numbers classified into the second group is smaller than the second set value set in advance (NO in step S10), the controller 70 terminates the process procedure without generating the correction parameters used to correct the projection image. At this point in time, the controller 70 may display a message on the projection receiving surface 3, the message prompting the user to change the position where the projection apparatus 1 is installed.

When the number of the pixel numbers classified into the second group is greater than or equal to the second set value set in advance (YES in step S10), the controller 70 generates the parameters that specify the projection receiving surface 3 based on the depth information at the pixels having the pixel numbers classified into the second group (step S11). At this point in time, the controller 70 may generate the parameters that specify the projection receiving surface 3 based on both the depth information at the pixels having the pixel numbers classified into the first group and the depth information at the pixels having the pixel numbers classified into the second group.

The controller 70 then generates the correction parameters used to correct the shape of the projection image to be projected onto the projection receiving surface 3 based on the generated parameters that specify the projection receiving surface 3 (step S12). Having generated the correction parameters, the controller 70 corrects the shape of the projection image by using the generated correction parameters (step S13), and projects the projection image having the corrected shape onto the projection receiving surface 3 (step S14).

The embodiments described above are preferred embodiments 41 the present disclosure. The present disclosure is, however, not limited to the embodiment described above, and various modifications are conceivable to the extent that the modifications do not depart from the key points of the present disclosure.

For example, in the embodiments described above, the case where the transmissive liquid crystal panels are provided as the light modulators is presented by way of example, and the liquid crystal panels may instead be reflective liquid crystal panels. The light modulators may each have a configuration in which the liquid crystal panel is replaced with a digital mirror device. The light modulators may have a configuration in which the digital mirror devices and a color wheel are combined with each other. Besides the liquid crystal panels and the digital mirror devices, the light modulators may each have a configuration capable of modulating the light output by a light source.

In the embodiments described above, the case where the projection apparatus 1 includes the distance sensor 20 has been described, but the distance sensor 20 and the projection apparatus 1 may be externally coupled to each other, and the projection apparatus 1 may acquire the sensor data from the externally coupled distance sensor 20.

The intensity information SI may be information on the intensity indicated by an output voltage output from the light receiving element corresponding to each of the pixels IM(1,1) to IM(6,6). Instead, when the distance sensor 20 is a ToF sensor and the distance sensor 20 generates an IR image by capturing an image of the projection receiving surface 3 with infrared light, the intensity information SI may be information on the intensity indicated by the magnitude of a signal output from the light receiving element described above based on the IR image. Still instead, when the light receiving element calculates pseudo reflectance substantially indicating the ratio of the amount of the reflected light received by the light receiving element to the amount of the projected light, the intensity information SI may, for example, be information on the intensity indicated by the pseudo reflectance.

Each of the functional portions of the projection apparatus 1 shown in FIG. 1 shows a functional configuration, and is not necessarily implemented in a specific form. That is, hardware individually corresponding to each of the functional portions is not necessarily required to be implemented, and a configuration in which one processor executes a program to realize the functions of multiple functional portions can, of course, be employed. Some of functions realized by software in the embodiments described above may be realized by hardware, and some of functions realized by hardware in the embodiments may be realized by software. In addition, the specific detailed configuration of each of the other portions of the projector can be freely changed to the extent that the change does not depart from the intent of the present disclosure.

The procedure of the flowchart shown in FIG. 9 has been divided into process units in accordance with primary process contents to facilitate understanding of the processes carried out by the projection apparatus 1. The present disclosure is not limited by how to divide the process units and the names thereof shown in the flowchart shown in FIG. 9. A process carried out by the projection apparatus 1 can be further divided into a larger number of process units in accordance with the content of the process, and the process units can each further be divided into a large number of processes. Furthermore, the process order of the flowchart described above is not limited to that shown in FIG. 9.

### 3. Summary of Present Disclosure

The present disclosure will be summarized below in the form of additional remarks.

### Additional Remark 1

A method for correcting a projection image to be projected by a projection apparatus onto a projection receiving surface, the method including: acquiring multiple pieces of depth information indicating multiple distances from a distance sensor to multiple positions on the projection receiving surface based on an output from the distance sensor, the distance sensor configured to irradiate the projection receiving surface with radiation light and receive reflected light that is the radiation light reflected off the projection receiving surface; acquiring multiple pieces of intensity information indicating intensities of the reflected light at the multiple positions; calculating, for each of the multiple positions, an evaluation value used to evaluate accuracy of measurement of the distance indicated by the corresponding depth information based on the intensity indicated by the corresponding intensity information; determining whether the evaluation value satisfies a first condition under which the measurement accuracy is evaluated; determining whether the evaluation value determined not to satisfy the first condition satisfies a second condition in which the measurement accuracy is more relaxed than in the first condition; generating a parameter that specifies the projection receiving surface based on at least one of the depth information derived from the reflected light providing the evaluation value satisfying the first condition and the depth information derived from the reflected light providing the evaluation value satisfying the second condition; and correcting the projection image based on the parameter.

In the correction method according to Additional Remark 1, the evaluation value used to evaluate the accuracy of the measurement of the distance indicated by the depth information is generated for each of the multiple positions; it is determined whether the evaluation value satisfies the first condition under which the measurement accuracy is evaluated; it is determined whether the evaluation value determined not to satisfy the first condition satisfies the second condition, in which the measurement accuracy is more relaxed than in the first condition; and a parameter that specifies the projection receiving surface is generated based on at least one of the depth information at a position where the generated evaluation value satisfies the first condition and the depth information at a position where the generated evaluation value satisfies the second condition, in which the measurement accuracy is more relaxed than in the first condition. Therefore, when the parameter that specifies the projection receiving surface cannot be generated only with the depth information at the position where the evaluation value satisfies the first condition, the parameter that specifies the projection receiving surface is generated based on the depth information at the position where the evaluation value satisfies the second condition, in which the measurement accuracy is more relaxed. Therefore, when the parameter cannot be generated only with the depth information satisfying the first condition, or when the accuracy decreases only with the first condition, the parameter that specifies the projection receiving surface can be generated by also using the depth information satisfying the second condition. The accuracy of the parameter that specifies the projection receiving surface can therefore be maintained while the ranges of the distance and the angle over which the projection image can be corrected are relaxed.

### Additional Remark 2

The correction method according to Additional Remark 1, wherein the parameter is not generated based on the depth information at a position where the evaluation value does not satisfy either the first condition or the second condition.

In the correction method according to Additional Remark 2, the parameter is not generated based on the depth information at a position where the evaluation value does not satisfy either the first condition or the second condition. A decrease in the accuracy of the parameter that specifies the projection receiving surface can therefore be suppressed.

### Additional Remark 3

The correction method according to Additional Remark 1 or 2, wherein the depth information and the intensity information are acquired at multiple points in time, and generating the parameter includes generating the parameter based on the depth information at one or more points in time at a position where the evaluation value satisfies the first condition and the depth information at one or more points in time at a position where the evaluation value satisfies the second condition.

In the correction method according to Additional Remark 3, the parameter that specifies the projection receiving surface is generated based on the depth information measured at the multiple points in time at the same position. The accuracy of the depth information and the accuracy of the correction of the projection image can therefore be improved.

### Additional Remark 4

The correction method according to Additional Remark 2, generating wherein the parameter includes generating the parameter by using a weighted least squares method along with the depth information and the intensity information, the weighted least squares method using the intensities indicated by the multiple pieces of intensity information as weights.

In the correction method according to Additional Remark 4, the parameter that specifies the projection receiving surface is generated by the weighted least squares method using the intensity indicated by the intensity information as a weight. The accuracy of the depth information and the accuracy of the correction of the projection image can therefore be improved.

### Additional Remark 5

The correction method according to Additional Remark 2, wherein the depth information and the intensity information are acquired at multiple points in time, and generating the parameter includes calculating a weighted average of the distances indicated by the multiple pieces of depth information at the multiple points in time by using intensities indicated by the multiple pieces of intensity information at the multiple points in time as weights, and generating the parameter based on the calculated weighted average.

In the correction method according to Additional Remark 5, the weighted average of the distances indicated by the multiple pieces of depth information at the multiple points in time is calculated, and the parameter that specifies the projection receiving surface is generated based on the calculated weighted average. The accuracy of the depth information and the accuracy of the correction of the projection image can therefore be improved.

### Additional Remark 6

The correction method according to any one of Additional Remarks 1 to 3, further including: acquiring the depth information and the intensity information at at least some positions that are contained in the multiple positions and are adjacent to each other; calculating a weighted average of the distances indicated by the multiple pieces of depth information at the at least some positions by using intensities indicated by the multiple pieces of the acquired intensity information at the at least some positions adjacent to each other as weights; and generating the parameter based on the calculated weighted average.

In the correction method according to Additional Remark 6, the depth information and the intensity information at at least some positions adjacent to each other are acquired, the weighted average of the distances indicated by the multiple pieces of depth information is calculated, and the parameter that specifies the projection receiving surface is generated based on the calculated weighted average. The accuracy of the depth information and the accuracy of the correction of the projection image can therefore be improved.

### Additional Remark 7

A projection apparatus including: a projector configured to project a projection image onto a projection receiving surface; and one or more processors, wherein the one or more processors are configured to acquire multiple pieces of depth information indicating multiple distances from a distance e sensor to multiple positions on the projection receiving surface based on an output from the distance sensor, the distance sensor configured to irradiate the projection receiving surface with radiation light and receive reflected light that is the radiation light reflected off the projection receiving surface, acquire multiple pieces of intensity information indicating intensities of the reflected light at the multiple positions, calculate, for each of the multiple positions, an evaluation value used to evaluate accuracy of measurement of the distance indicated by the corresponding depth information based on the intensity indicated by the corresponding intensity information, determine whether the evaluation value satisfies a first condition under which the measurement accuracy is evaluated, determine whether the evaluation value determined not to satisfy the first condition satisfies a second condition in which the measurement accuracy is more relaxed than in the first condition, generate a parameter that specifies the projection receiving surface based on at least one of the depth information derived from the reflected light providing the evaluation value satisfying the first condition and the depth information derived from the reflected light providing the evaluation value satisfying the second condition, and correct the projection image based on the parameter.

In the projection apparatus according to Additional Remark 7, the evaluation value used to evaluate the accuracy of the measurement of the distance indicated by the depth information is generated for each of the multiple positions; it is determined whether the evaluation value satisfies the first condition under which the measurement accuracy is evaluated; it is determined whether the evaluation value determined not to satisfy the first condition satisfies the second condition, in which the measurement accuracy is more relaxed than in the first condition; and a parameter that specifies the projection receiving surface is generated based on at least one of the depth information at a position where the generated evaluation value satisfies the first condition and the depth information at a position where the generated evaluation value satisfies the second condition, in which the measurement accuracy is more relaxed than in the first condition. Therefore, when the parameter that specifies the projection receiving surface cannot be generated only with the depth information at the position where the evaluation value satisfies the first condition, the parameter that specifies the projection receiving surface is generated based on the depth information at the position where the evaluation value satisfies the second condition, in which the measurement accuracy is more relaxed. Therefore, when the parameter cannot be generated only with the depth information satisfying the first condition, the parameter that specifies the projection receiving surface can be generated by also using the depth information satisfying the second condition. The accuracy of the parameter that specifies the projection receiving surface can therefore be maintained while the ranges of the distance and the angle over which the projection image can be corrected are relaxed.

What is claimed is:

1. A method for correcting a projection image to be projected by a projection apparatus onto a projection receiving surface, the method comprising:
acquiring multiple pieces of depth information indicating multiple distances from a distance sensor to multiple positions on the projection receiving surface based on an output from the distance sensor, the distance sensor configured to irradiate the projection receiving surface with radiation light and receive reflected light that is the radiation light reflected off the projection receiving surface;
acquiring multiple pieces of intensity information indicating intensities of the reflected light at the multiple positions;
calculating, for each of the multiple positions, an evaluation value used to evaluate accuracy of measurement of the distance indicated by the corresponding depth information based on the intensity indicated by the corresponding intensity information;
determining whether the evaluation value satisfies a first condition under which the measurement accuracy is evaluated;
determining whether the evaluation value determined not to satisfy the first condition satisfies a second condition in which the measurement accuracy is more relaxed than in the first condition;
generating a parameter that specifies the projection receiving surface based on at least one of the depth information derived from the reflected light providing the evaluation value satisfying the first condition and the depth information derived from the reflected light providing the evaluation value satisfying the second condition; and
correcting the projection image based on the parameter.

2. The correction method according to claim 1, wherein
the parameter is not generated based on the depth information at a position where the evaluation value does not satisfy either the first condition or the second condition.

3. The correction method according to claim 1, wherein
the depth information and the intensity information are acquired at multiple points in time, and
generating the parameter includes generating the parameter based on the depth information at one or more points in time at a position where the evaluation value satisfies the first condition and the depth information at one or more points in time at a position where the evaluation value satisfies the second condition.

4. The correction method according to claim 2, wherein
generating the parameter includes generating the parameter by using a weighted least squares method along with the depth information and the intensity information, the weighted least squares method using the intensities indicated by the multiple pieces of intensity information as weights.

5. The correction method according to claim 2, wherein
the depth information and the intensity information are acquired at multiple points in time, and
generating the parameter includes calculating a weighted average of the distances indicated by the multiple pieces of depth information at the multiple points in time by using intensities indicated by the multiple pieces of intensity information at the multiple points in time as weights, and generating the parameter based on the calculated weighted average.

6. The correction method according to claim 1, further comprising:
acquiring the depth information and the intensity information at at least some positions that are contained in the multiple positions and are adjacent to each other;
calculating a weighted average of the distances indicated by the multiple pieces of depth information at the at least some positions by using intensities indicated by the multiple pieces of the acquired intensity information at the at least some positions adjacent to each other as weights; and
generating the parameter based on the calculated weighted average.

7. A projection apparatus comprising:
a projector configured to project a projection image onto a projection receiving surface; and
one or more processors,
wherein the one or more processors are configured to
acquire multiple pieces of depth information indicating multiple distances from a distance sensor to multiple positions on the projection receiving surface based on an output from the distance sensor, the distance sensor configured to irradiate the projection receiving surface with radiation light and receive reflected light that is the radiation light reflected off the projection receiving surface,
acquire multiple pieces of intensity information indicating intensities of the reflected light at the multiple positions,
calculate, for each of the multiple positions, an evaluation value used to evaluate accuracy of measurement of the distance indicated by the corresponding depth information based on the intensity indicated by the corresponding intensity information,
determine whether the evaluation value satisfies a first condition under which the measurement accuracy is evaluated,
determine whether the evaluation value determined not to satisfy the first condition satisfies a second condition in which the measurement accuracy is more relaxed than in the first condition,
generate a parameter that specifies the projection receiving surface based on at least one of the depth information derived from the reflected light providing the evaluation value satisfying the first condition and the depth information derived from the reflected light providing the evaluation value satisfying the second condition, and
correct the projection image based on the parameter.
